(19) United States
(12) Patent Application Publication
(10) Pub. No.: US 2006/0109793 A1
(43) Pub. Date: May 25, 2006

(54) Network simulation apparatus and method for analyzing abnormal network

(76) Inventors: Hwan Kuk Kim, Seoul (KR); Yang Seo Choi, Daejeon-city (KR); Dong Il Seo, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/123,278

(22) Filed: May 6, 2005

(30) Foreign Application Priority Data
Nov. 25, 2004 (KR) 10-2004-0097474

(51) Int. Cl. H04J 1/16

(52) U.S. Cl. 370/250

(57) ABSTRACT

A network simulation apparatus and method for analyzing abnormal network traffic are provided. The network simulation apparatus includes: a traffic information collection unit, which collects traffic information in real time from a network; a simulator, which performs a simulation operation in a virtual network topology environment according to a predetermined scenario, the virtual network topology environment generating virtual traffic including a normal virtual packet modeled based on a normal traffic environment and an abnormal virtual packet modeled based on an abnormal traffic environment with a network traffic attack launched thereupon based on the collected real-time traffic information; and an interface unit, which provides the simulation operation results to a user. Accordingly, it is possible to effectively detect, analyze, and deal with abnormal network traffic that has occurred in a network to be managed.

### CROSS-REFERENCE TO RELATED PATENT APPLICATION

This application claims the benefit of Korean Patent Application No. 10-2004-0097474, filed on Nov. 25, 2004, in the Korean Intellectual Property Office, the disclosure of which is incorporated herein in its entirety by reference.

### BACKGROUND OF THE INVENTION

1. Field of the Invention

The present invention relates to a network simulation apparatus and method, and more particularly, to a network simulation apparatus and method which analyze abnormal network attacks.

2. Description of the Related Art

Various dynamic characteristics and the performance of a network can be measured by establishing a virtual network environment using network simulation technology, which is widely used for identifying the characteristics of new communication theories or algorithms and comparing the new communication theories or algorithms with existing communication theories or algorithms.

The scale of cyber attacks through the Internet has broadened from a PC or a system level to a network level. Thus, it is almost impossible to efficiently protect against Internet-based attacks, such as abnormal network attacks, simply using conventional firewalls or intrusion detection systems. Accordingly, it is necessary to develop network security technology, and particularly, integrated security management technology, which can readily detect, precisely analyze, and effectively deal with an intrusion on a network so as to safely protect network infrastructure.

In a conventional network security method of detecting and analyzing abnormal network traffic attacks, network traffic is measured and analyzed using mathematical modeling based on statistics. However, it is difficult to analyze the direction of a large-scale network traffic attack and cope with the large-scale network traffic attack simply using such a statistical method.

### SUMMARY OF THE INVENTION

The present invention provides a network simulation apparatus and method, which analyze and estimate abnormal network traffic using various scenarios built up based on real-time traffic information of a network to be managed.

According to an aspect of the present invention, there is provided a network simulation apparatus for analyzing abnormal network traffic. The network simulation apparatus includes: a traffic information collection unit, which collects traffic information in real time from a network; a simulator, which performs a simulation operation in a virtual network topology environment according to a predetermined scenario, the virtual network topology environment generating virtual traffic including a normal virtual packet modeled based on a normal traffic environment and an abnormal virtual packet modeled based on an abnormal traffic environment with a network traffic attack launched thereupon based on the collected real-time traffic information; and an interface unit, which provides the simulation operation results to a user.

According to another aspect of the present invention, there is provided a network simulation method for analyzing abnormal network traffic. The network simulation method includes: collecting traffic information in real time from a network; performing a simulation operation in a virtual network topology environment according to a predetermined scenario, the virtual network topology environment generating virtual traffic including a normal packet modeled based on a normal traffic environment and an abnormal packet modeled based on an abnormal traffic environment with a network traffic attack launched thereupon based on the collected real-time traffic information; and providing the simulation operation results to a user.

Accordingly, it is possible to detect and analyze abnormal traffic of a network to be managed and to take appropriate measures to tackle the abnormal network traffic.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a network simulation apparatus for analyzing abnormal network traffic according to an exemplary embodiment of the present invention;

FIG. 2 is a detailed block diagram illustrating a simulator of FIG. 1;

FIG. 3 is a block diagram illustrating virtual network elements and a method of dealing with abnormal network traffic using the virtual network elements;

FIG. 4 is a state transition diagram of a traffic control agent of FIG. 3;

FIG. 5 is a state transition diagram of a security management agent of FIG. 3; and

FIG. 6 is a flowchart illustrating a network simulation method of analyzing abnormal network traffic according to an exemplary embodiment of the present invention.

### DETAILED DESCRIPTION OF THE INVENTION

A network simulation apparatus and method for analyzing abnormal network traffic according to the present invention will now be described more fully with reference to the accompanying drawings in which exemplary embodiments of the invention are shown.

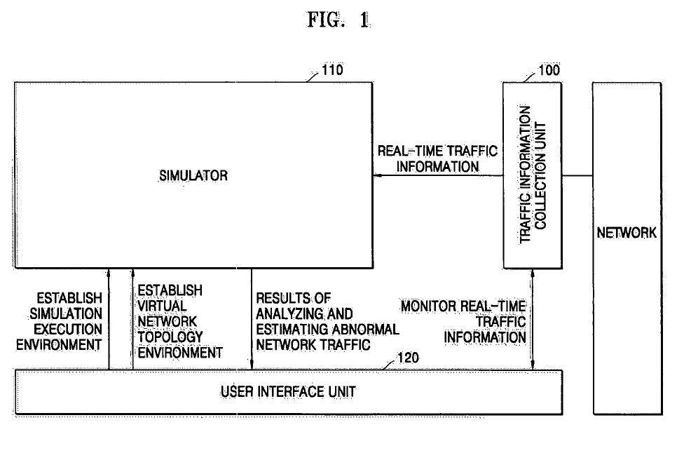

FIG. 1 is a block diagram illustrating a network simulation apparatus for analyzing abnormal network traffic according to an exemplary embodiment of the present invention. Referring to FIG. 1, the network simulation apparatus includes a traffic information collection unit 100, a simulator 110, and a user interface unit 120.

The traffic information collection unit 100 collects traffic information in real time from a network, converts the collected real-time traffic information to be compatible with a simulation environment of the simulator 110, and transmits the converted real-time traffic information to the simulator 110.

The simulator 110 performs a simulation operation in a virtual network topology environment that generates virtual traffic, including a normal virtual packet modelled based on a normal network traffic environment and an abnormal virtual packet modelled based on an abnormal network traffic environment, based on the converted real-time traffic information received from the traffic information collection unit 110 on according to a predetermined scenario. The predetermined scenario may change in consideration of the state of a network to be managed.

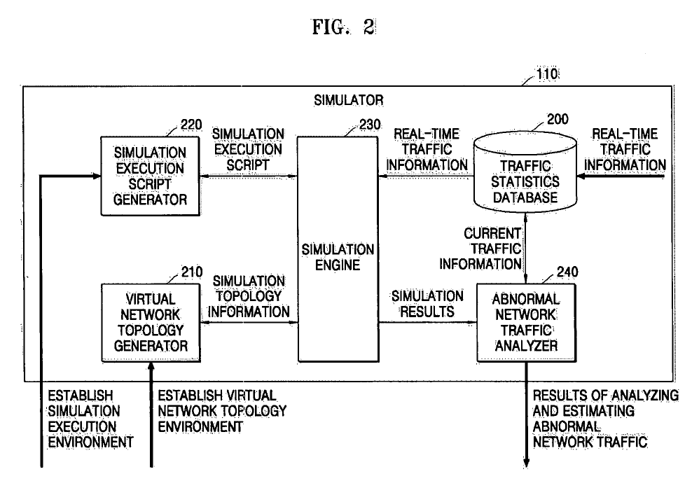

Results of the simulation operation carried out by the simulator 110 include information on the amount of traffic at current time and information on network bandwidths that are expected to be available after a network to be managed undergoes abnormal network traffic control and bandwidth restriction. Thereafter, the simulator 110 determines whether the network to be managed currently confronts abnormal network traffic and obtains estimates regarding the availability of the network to be managed by analyzing the simulation operation results and the collected real-time traffic information. The structure and operation of the simulator 110 will be described later in further detail with reference to FIG. 2.

The user interface unit 120 provides the real-time traffic information collected by the traffic information collection unit 100 to a user, receives setting values regarding a simulation environment, and particularly, regarding the virtual network topology environment, virtual network elements, and a simulation execution schedule, from the user, and provides the received setting values to the simulator 110. In addition, the user interface unit 120 provides the simulation operation results to the user. In other words, the user interface unit 120 interfaces with the user.

The virtual network elements, which are used in a simulation operation for detecting and analyzing abnormal network traffic, are modelled so that they can detect abnormal network traffic affecting the virtual network, can collect signs of abnormal network traffic from network equipment, and can adjust or cut off bnormal network traffic flow if abnormal network traffic is detected.

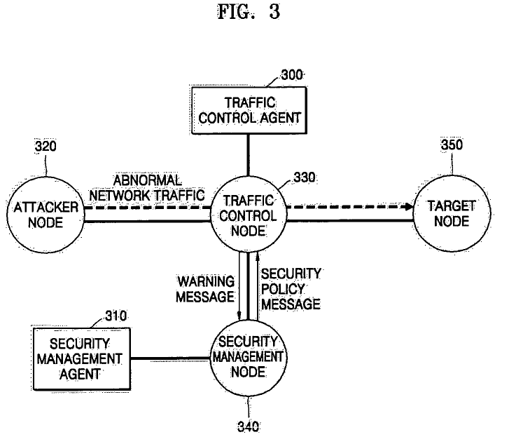

Examples of the virtual network elements include a traffic generation unit, which creates virtual normal network traffic and virtual abnormal network traffic based on the actual amount of traffic, a security management agent, which establishes a virtual network topology simulation environment, and a traffic control agent, which detects and controls abnormal network traffic. The virtual network elements and a method of dealing with abnormal network traffic using the virtual network elements will be described later in detail with reference to FIGS. 3 through 5.

FIG. 2 is a detailed block diagram illustrating the simulator 110 of FIG. 1. Referring to FIG. 2, the simulator 110 includes a traffic statistics database 200, a virtual network topology generator 210, a simulation execution script generator 220, a simulation engine 230, and an abnormal traffic analyzer 240.

The traffic statistics database 200 stores real-time traffic information of the network to be managed collected by the traffic information collection unit 100 of FIG. 1. A user can monitor statistical values regarding the real-time traffic information stored in the traffic statistics database 200 using the user interface unit 120 of FIG. 1.

The virtual network topology generator 210 creates a virtual network topology environment, which is comprised of virtual network elements. The user can establish the virtual network topology environment using the user interface unit 120. The virtual network elements are a traffic generation unit, which creates virtual network traffic, a security management node, which establishes a virtual network topology simulation environment, and a traffic control node, which detects and controls abnormal network traffic.

The simulation execution script generator 220 creates virtual traffic including a normal virtual packet modelled based on a normal network traffic environment and an abnormal virtual packet modelled based on an abnormal network traffic environment with a network traffic attack launched thereupon using the real-time traffic information stored in the traffic statistics database 200 and defines an event schedule.

The simulation engine 230 performs a simulation operation in the virtual network topology environment created by the virtual network topology generator 210 according to the event schedule defined by the simulation execution script generator 220. Results of the simulation operation carried out by the simulation engine 230 include information on the amount of traffic at current time and information on network bandwidths that are expected to be available after abnormal network traffic control and bandwidth restriction.

The abnormal traffic analyzer 240 compares the simulation operation results with the statistical values regarding the real-time traffic information stored in the traffic statistics database 200, determines whether abnormal network traffic has occurred in the network to be managed based on the comparison results, and calculates estimated data regarding the availability of the network to be managed based on the comparison results.

FIG. 3 is a block diagram illustrating virtual network elements and a method of dealing with abnormal network traffic using the virtual network elements. Referring to FIG. 3, the virtual network elements include an attacker node 320, a traffic control node 330, a security management node 340, and a target node 350. The traffic control node 330 includes a traffic control agent 300, which detects abnormal network traffic, and the security management node 340 includes a security management agent 310, which takes measures to deal with abnormal network traffic.

The attacker node 320 creates virtual traffic including a normal virtual packet and an abnormal virtual packet based on real-time traffic amount of a network to be managed and transmits the virtual traffic to the target node 350. The traffic control node 330 is located between the attacker node 320 and the target node 350 and detects abnormal network traffic. The traffic control agent 300 of the traffic control node 330 creates a warning message and transmits it to the security management agent 310 of the security management node 340 when abnormal network traffic is detected.

The security management node 340 establishes a security policy, for example, controlling abnormal network traffic or network bandwidths, and transmits the security policy to the traffic control node 330.

The traffic control node 330 takes appropriate measures to deal with abnormal network traffic based on the received security policy by, for example, controlling network traffic and bandwidths.

FIG. 4 is a state transition diagram of the traffic control agent 300 of FIG. 3.

Referring to FIG. 4, the traffic control agent 300 may fall into one of the following states: an initial state 400; a virtual packet reception state 405; an abnormal network traffic detection state 410; a security policy storage state 415; and a termination state 420.

In the initial state 400, the traffic control agent 300 stands by to receive a virtual packet. If the traffic control agent 300 receives a virtual packet in the initial state 400, it makes a transition to the virtual packet reception state 405 in operation S450.

In the virtual packet reception state 405, the traffic control agent 300 checks a header of the received virtual packet and determines whether the received virtual packet is related to a traffic control security policy received from the security management agent 310. If the received virtual packet is related to the traffic control security policy received from the security management agent 310, the traffic control agent 300 makes a transition from the virtual packet reception state 405 to the security policy storage state 415 and stores the traffic control security policy related to the received virtual packet.

If the received virtual packet is an abnormal packet, the traffic control agent 300 makes a transition from the virtual packet reception state 405 to the abnormal traffic detection state 410 in operation S460. In the abnormal packet detection state 410, the traffic control agent 300 references the stored traffic control security policy and determines whether to send a warning message or to take appropriate measures to deal with abnormal network traffic according to the stored traffic control security policy in operation S465.

The traffic control agent 300 creates and sends a warning message in operation S475 or cuts off traffic in operation S470 according to the determination results obtained in operation S465 and makes a transition to the termination state 420.

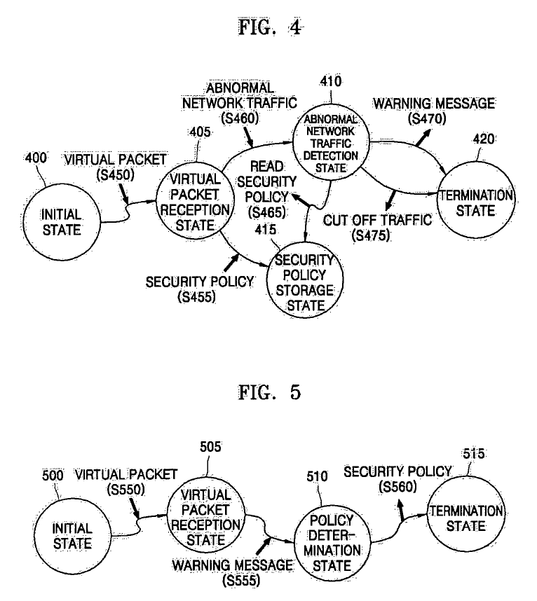

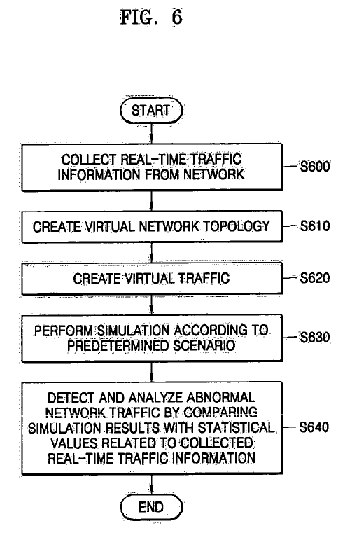

FIG. 5 is a state transition diagram of the security management agent 310 of FIG. 3. Referring to FIG. 5, the security management agent 310 may fall into one of the following states: an initial state 500; a virtual packet reception state 505; a security policy determination state 510; and a termination state 515.

In the initial state 510, the security management agent 310 stands by to receive a virtual packet. If the security management agent 310 receives a virtual packet in the initial state 500, it makes a transition to the virtual packet reception state 500 in operation S550. In the virtual packet reception state 505, the security management agent 310 checks a header of the received virtual packet and determines whether the received virtual packet is related to a warning message sent by the traffic control agent 300.

If the received virtual packet is related to a warning message sent by the traffic control agent 300, the security management agent 310 makes a transition from the virtual packet reception state 505 to the security policy determination state 510 in operation S555, establishes a security policy with reference to the warning message sent by the traffic control agent 300, transmits the security policy to the traffic control node 300, and makes a transition to the termination state 515 in operation S560.

FIG. 6 is a flowchart illustrating a network simulation method of analyzing abnormal network traffic according to an exemplary embodiment of the present invention. Referring to FIG. 6, in operation S600, traffic information is collected in real time from a local network to be analyzed, and the collected real-time traffic information is appropriately converted to be compatible with a network simulation environment.

In operation S610, a virtual network topology environment is created through modelling of virtual network elements. In operation S620, virtual traffic including a normal virtual packet, which is modelled based on a normal network environment, and an abnormal virtual packet, which is modelled based on an abnormal network environment with a network traffic attach launched thereupon, is created with reference to the collected real-time traffic information of the local network to be analyzed.

In operation S630, a simulation operation is performed on the virtual traffic in the virtual network topology environment according to a predetermined event schedule.

In operation S640, the simulation operation results are compared with statistical values regarding the collected real-time traffic information of the local network to be analyzed, it is determined whether abnormal network traffic has occurred in the local network to be analyzed based on the comparison results, and appropriate measures to deal with abnormal network traffic, such as cutting off abnormal network traffic or controlling network bandwidths, are taken. The present invention can be realized as computer-readable codes written on a computer-readable recording medium. Examples of the computer-readable recording medium include nearly all kinds of recording apparatuses on which data is stored in such a computer-readable manner. For example, the computer-readable recording medium may be a ROM, a RAM, a CD-ROM, a magnetic tape, a floppy disc, an optical data storage, or a carrier wave (e.g., data transmission through the Internet). The computer-readable recording medium can be distributed over a plurality of computer systems connected to a network so that codes can be written on or read from the computer-readable recording medium in a decentralized manner.

According to the present invention, it is possible to gather traffic information in real time from a network to be managed in a virtual network topology environment established through modeling and to carry out a simulation operation according to various scenarios using the gathered real-time traffic information.

In addition, it is possible to determine whether abnormal network traffic has. occurred in the network to be managed and to estimate the availability of the network to be managed by analyzing the simulation operation results and the gathered real-time traffic information.

Moreover, it is possible to overcome the limits of a conventional statistics-based network traffic detection and analysis method and to provide an effective simulation-based network traffic detection and analysis method by applying an existing network security solution to a virtual simulator.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A network simulation apparatus for analyzing abnormal network traffic comprising:
a traffic information collection unit, which collects traffic information in real time from a network;
a simulator, which performs a simulation operation in a virtual network topology environment according to a predetermined scenario, the virtual network topology environment generating virtual traffic including a normal virtual packet modeled based on a normal traffic environment and an abnormal virtual packet modeled based on an abnormal traffic environment with a network traffic attack launched thereupon based on the collected real-time traffic information; and
an interface unit, which provides the simulation operation results to a user.

2. The network simulation apparatus of claim 1, wherein the traffic information collection unit converts the collected real-time traffic information to be compatible with the virtual network topology environment.

3. The network simulation apparatus of claim 1, wherein the simulator comprises:
a traffic statistics database, which stores the collected real-time traffic information received from the traffic information collection unit;
a virtual network topology generator, which creates the virtual network topology environment through modeling of virtual network elements;
a simulation execution script generator, which creates the virtual traffic based on the collected real-time traffic information stored in the traffic statistics database and defines an event schedule;
a simulation engine, which performs a simulation operation on the virtual traffic in the virtual network topology environment created by the virtual network topology generator according to the event schedule defined by the simulation execution script generator; and
an abnormal traffic analyzer, which analyzes abnormal network traffic by comparing the simulation operation results with statistical values related to the collected real-time traffic information.

4. The network simulation apparatus of claim 1, wherein the virtual network topology environment comprises an attacker node, a traffic control node, and a security management node as the virtual network elements,
wherein the attacker node creates the virtual traffic based on the collected real-time traffic information,
the traffic control node controls abnormal network traffic caused by the abnormal virtual packet or control network bandwidths according to a predetermined security policy when it detects the abnormal network traffic, and
the security management node establishes the predetermined security policy and transmits it to the traffic control node when the traffic control node detects the abnormal network traffic.

5. The network simulation apparatus of claim 4, wherein the traffic control node comprises a traffic control agent, which creates a warning message and transmits it to the security management node when the traffic control node detects the abnormal network traffic, and the security management node comprises a security management agent, which establishes a security policy, including controlling the abnormal network traffic or network bandwidths, and transmits it to the traffic control node.

6. The network simulation apparatus of claim 5, wherein operating states of the traffic control agent comprise:
an initial state in which the traffic control agent stands by to receive a virtual packet;
a virtual packet reception state in which the traffic control agent determines whether a received virtual packet is an abnormal packet;
a security policy storage state in which the traffic control agent stores the security policy if the received virtual packet is an abnormal packet;
an abnormal network traffic detection state in which the traffic control agent establishes a security policy for dealing with the abnormal network traffic according to the security policy stored in the security policy storage state; and
a termination state in which the traffic control agent carries out the security policy established in the abnormal network traffic detection state.

7. The network simulation apparatus of claim 5, wherein operating states of the security management agent comprise:
an initial state in which the security management agent stands by to receive a virtual packet;
a virtual packet reception state in which the security management agent determines whether a received virtual packet is related to a warning message created by the traffic control agent;
a security policy determination state in which the security management agent establishes a security policy for controlling abnormal network traffic or network bandwidths if the received virtual packet is related to the warning message created by the traffic control agent; and
a termination state in which the security management agent transmits the established security policy to the traffic control agent.

8. A network simulation method for analyzing abnormal network traffic comprising:
collecting traffic information in real time from a network;
performing a simulation operation in a virtual network topology environment according to a predetermined scenario, the virtual network topology environment generating virtual traffic including a normal packet modeled based on a normal traffic environment and an abnormal packet modeled based on an abnormal traffic environment with a network traffic attack launched thereupon based on the collected real-time traffic information; and
providing the simulation operation results to a user.

9. The network simulation method of claim 8, wherein the collecting of the real-time traffic information comprises converting the collected real-time traffic information to be compatible with the virtual network topology environment.

10. The network simulation method of claim 8, wherein the performing of the simulation operation comprises:
creating the virtual traffic based on the collected real-time traffic information stored in the traffic statistics database and defining an event schedule;
creating the virtual network topology environment through modeling of virtual network elements;
performing a simulation operation on the virtual traffic in the virtual network topology environment according to the defined event schedule; and
analyzing abnormal network traffic by comparing the simulation operation results with statistical values related to the collected real-time traffic information.

11. A computer-readable recording medium storing a computer program for executing the network simulation method of claim 8.
